(19) United States
(12) Patent Application Publication
(10) Pub. No.: US 2022/0343792 A1
(43) Pub. Date: Oct. 27, 2022

(54) Writing Instruction Assembly

(71) Applicant: Mary Malinka, Franklin, IN (US)

(72) Inventor: Mary Malinka, Franklin, IN (US)

(21) Appl. No.: 17/240,197

(22) Filed: Apr. 26, 2021

(51) Int. Cl. G09B 19/00; G09B 1/08

(52) U.S. Cl. CPC G09B 19/00; G09B 1/08

(57) ABSTRACT

A writing instruction assembly includes a frame is comprised of a magnetic material. A plurality of style panels is provided and each of the style panels is assigned to a respective style of writing. Moreover, a respective one of the style panels is magnetically attachable to the frame to identify which style of writing will be performed. A plurality of instruction cards is provided and instructional indicia are printed on each of the instruction cards. The indicia on the plurality of instruction cards comprise words communicating writing steps. Moreover, the words on the instruction cards range between beginning steps of writing and ending steps of writing. The instruction cards are arranged on the frame to communicate a sequence of steps involved with writing to assist a student with learning the steps of writing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to writing devices and more particularly pertains to a new writing device for teaching students the process of writing. The device includes a magnetic frame, a plurality of magnetic style panels and a plurality of instructional cards. A respective one of the style panels is positionable on the frame to define the style of writing to be practiced and respective ones of the instructional cards are positioned on the frame to communicate the steps of writing in the style of writing.

### (2) Description of Related Art Including Information Disclosed Under 37 CFR 1.97 and 1.98

The prior art relates to writing devices including a frame with magnetic elements that can be magnetically attached to the frame. The prior art discloses a variety of educational devices that include a magnetic panel and magnetic game pieces that can be magnetically attached to the magnetic panel. The prior art discloses a writing system that includes color coded templates for teaching writing strategies. The prior art also discloses a magnetic picture frame assembly. In no instance does the prior art disclose a writing teaching device that includes a magnetic frame, magnetic style panels and a plurality of magnetic instructional cards.

### BRIEF SUMMARY OF THE INVENTION

An embodiment of the disclosure meets the needs presented above by generally comprising a frame is comprised of a magnetic material. A plurality of style panels is provided and each of the style panels is assigned to a respective style of writing. Moreover, a respective one of the style panels is magnetically attachable to the frame to identify which style of writing will be performed. A plurality of instruction cards is provided and instructional indicia are printed on each of the instruction cards. The indicia on the plurality of instruction cards comprise words communicating writing steps. Moreover, the words on the instruction cards range between beginning steps of writing and ending steps of writing. The instruction cards are arranged on the frame to communicate a sequence of steps involved with writing to assist a student with learning the steps of writing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a writing instruction assembly according to an embodiment of the disclosure.

FIG. 2 is a front view of a plurality of style panels of an embodiment of the disclosure.

FIG. 3 is a front view of a plurality of instruction cards of an embodiment of the disclosure.

FIG. 4 is a perspective in-use view of an embodiment of the disclosure.

FIG. 5 is a front in-use view of an embodiment of the disclosure.

FIG. 6 is a cross sectional view taken along line 6-6 of FIG. 4 of an embodiment of the disclosure.

FIG. 7 is a perspective view of a plurality of instruction cards of an embodiment of the disclosure.

### DETAILED DESCRIPTION OF THE INVENTION

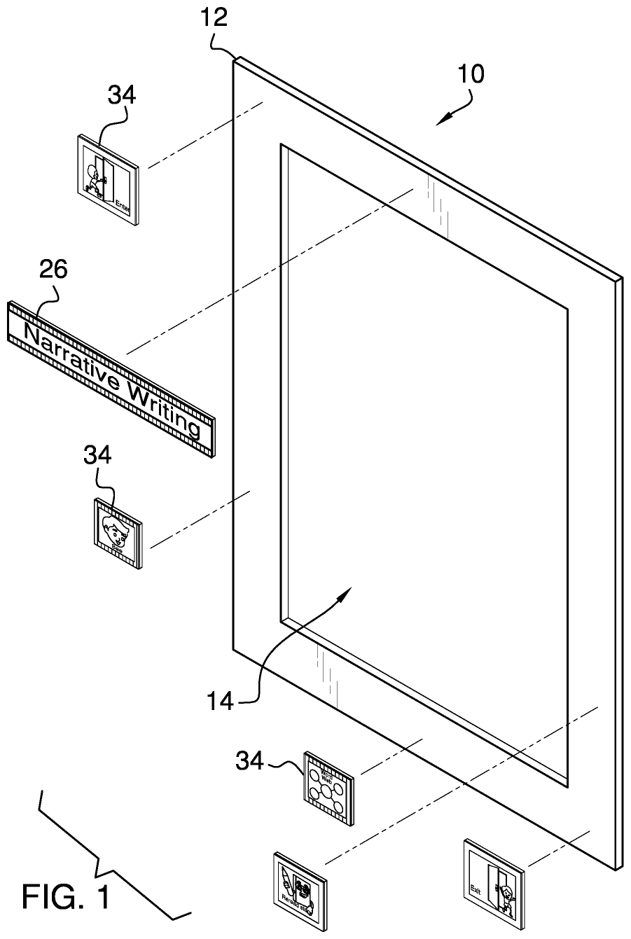

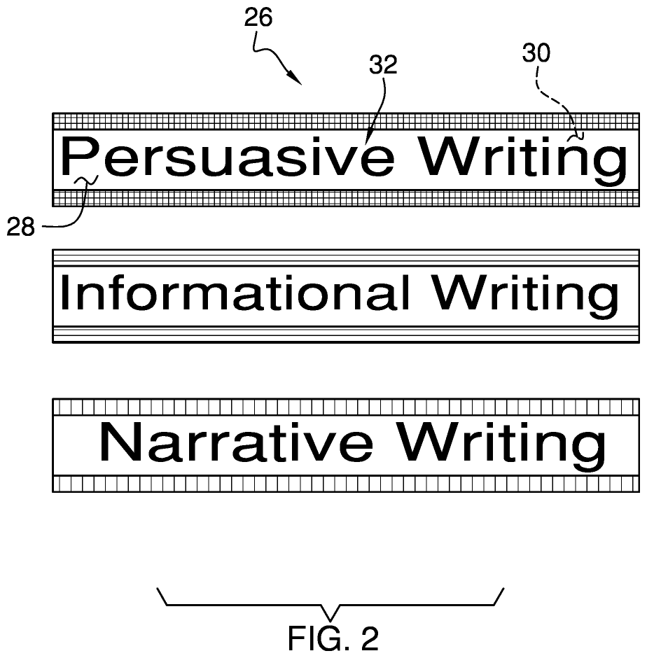

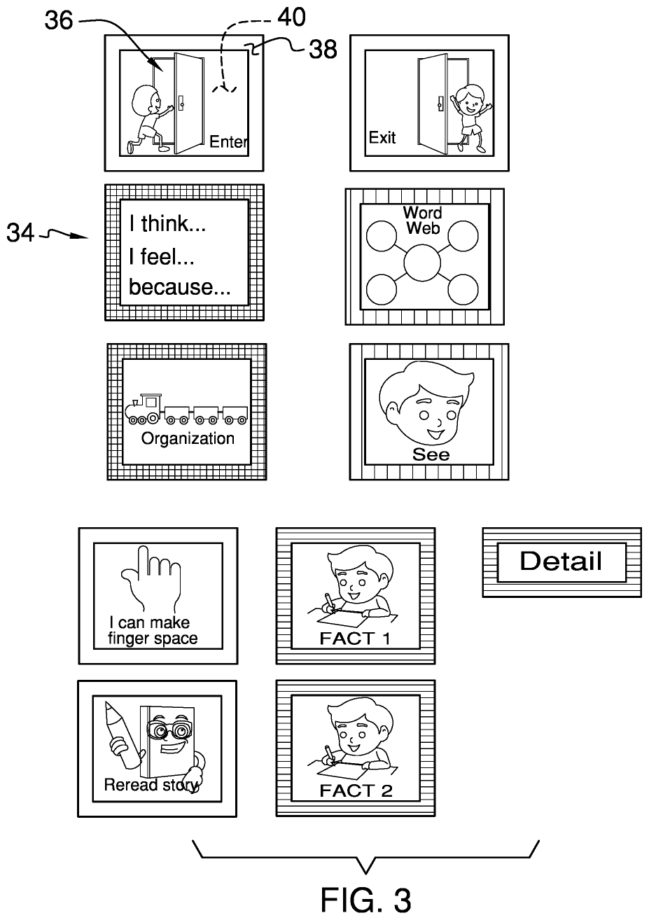

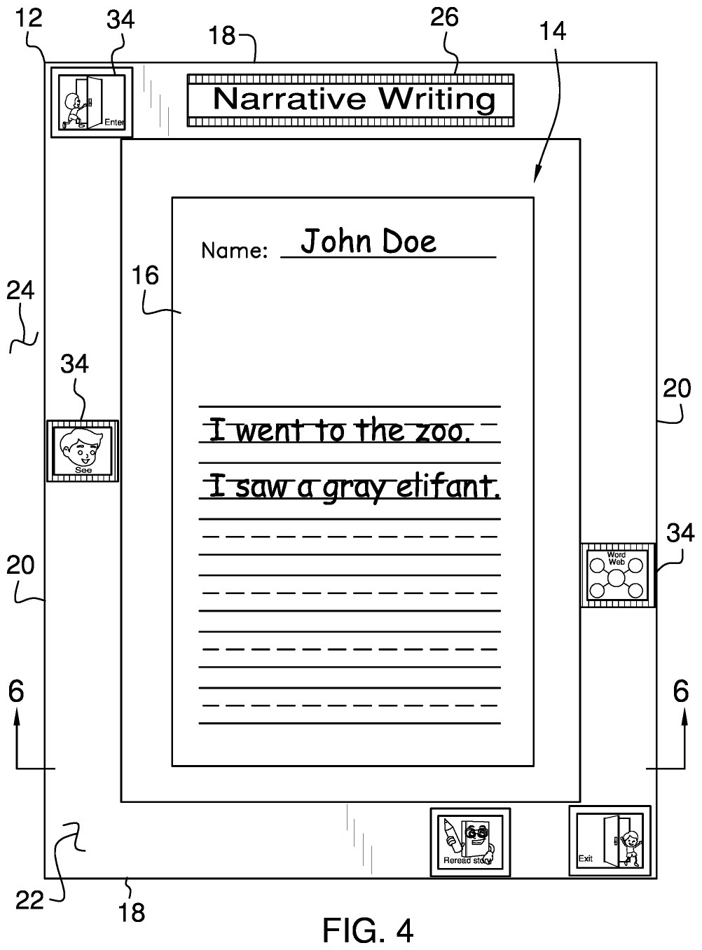

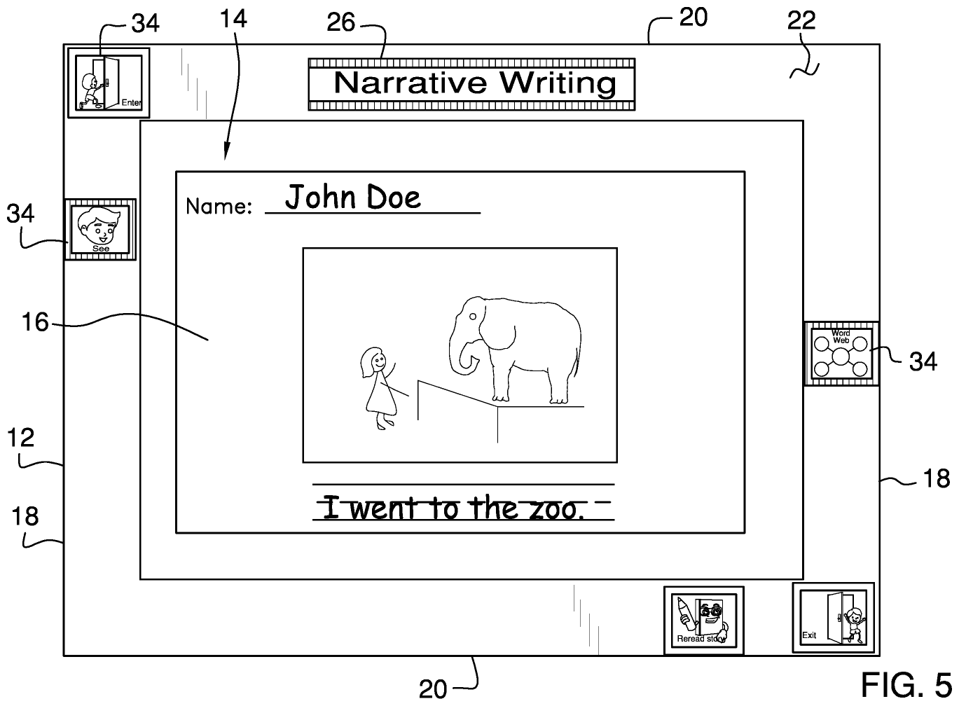

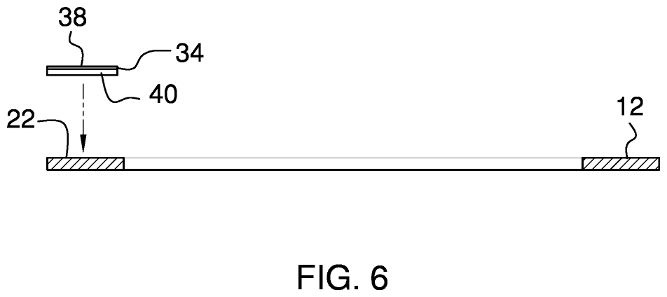

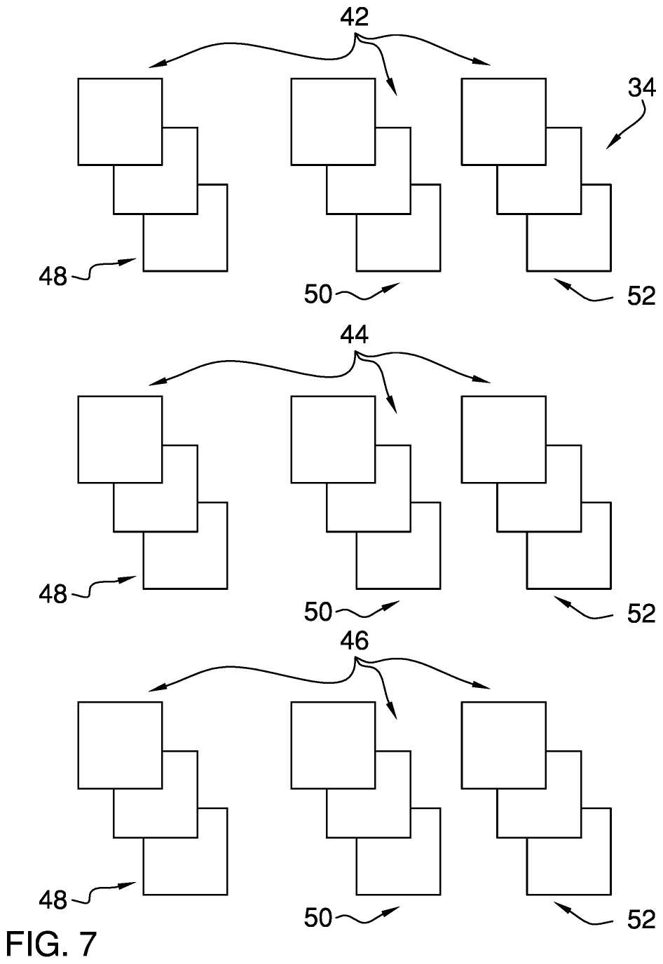

With reference now to the drawings, and in particular to FIGS. 1 through 7 thereof, a new writing device embodying the principles and concepts of an embodiment of the disclosure and generally designated by the reference numeral 10 will be described.

As best illustrated in FIGS. 1 through 7, the writing instruction assembly 10 generally comprises a frame 12 that is comprised of a magnetic material. The frame 12 defines a writing area 14 and a piece of writing paper 16 can be placed in the writing area 14. The frame 12 comprises a pair of first members 18 each extending between a pair of second members 20, and each of the first members 18 intersects each of the second members 20 at a right angle such that the frame 12 defines a rectangle. Each of the first members 18 and the second members 20 has a first surface 22 is exposed when the frame 12 is positioned on a support surface 24. Additionally, the writing area 14 may have a width of at least 8.5 inches and a height of at least 11.0 inches thereby facilitating the writing area 14 to accommodate common sizes of writing paper.

A plurality of style panels 26 is provided and each of the style panels 26 is comprised of a magnetic material. Each of the style panels 26 is assigned to a respective style of writing and a respective one of the style panels 26 is magnetically attachable to the frame 12. In this way the respective style panel identifies which style of writing will be performed by a student. Each of the style panels 26 has a primary surface 28 and a secondary surface 30, and the primary surface 28 of each of the style panels 26 has indicia 32 printed therein. The indicia 32 on respective ones of the style panels 26 comprise the words “narrative writing”, “persuasive writing” and “informational writing”. Additionally, the secondary surface 30 of a respective of the style panels 26 magnetically engages the first surface 22 of the frame 12 when the respective style panel 26 is positioned on the frame 12.

A plurality of instruction cards 34 is provided and each of the instruction cards 34 is comprised of a magnetic material. Each of the instruction cards 34 has instructional indicia 36 printed thereon and the instructional indicia 36 on the plurality of instruction cards 34 comprise words and imagery communicating writing steps. Moreover, the words on the instruction cards 34 range between beginning steps of writing and ending steps of writing. In this way, the instruction cards 34 can be arranged on the frame 12 such that the words on the instruction cards 34 communicates a sequence of steps involved with writing to assist students with varying levels of skill to learn the steps of writing.

Each of the plurality of instruction cards 34 has a primary surface 38 and a secondary surface 40, and the instructional indicia 36 on each of the instruction cards 34 are printed on the primary surface 38 of the instruction cards 34. The secondary surface 40 of respective ones of the instruction cards 34 magnetically engages the first surface 22 of the frame 12 when the respective instruction cards 34 are positioned on the frame 12. In this way the respective instruction cards 34 are inhibited by being displaced on the frame 12 while the student is writing.

The plurality of instruction cards 34 comprises a set of persuasive writing cards 42, a set of informational writing cards 44 and a set of narrative writing cards 46. The instructional indicia 36 on each of the persuasive writing cards 42 comprise words communicating steps involved with persuasive writing. The instructional indicia 36 on each of the informational writing cards 44 comprise words communicating steps involved with informational writing. Continuing, the instructional indicia 36 on each of the narrative writing cards 46 comprise words communicating steps involved with narrative writing. The words communicating the steps with persuasive writing, informational writing and narrative writing may conform with approved teaching methods commonly employed in public schools and private schools.

Each of the set of persuasive writing cards 42, the set of informational writing cards 44 and the set of narrative writing cards 46 includes a collection of beginner cards 48, a collection of intermediate cards 50 and a collection of advanced cards 52. The instructional indicia 36 on the collection of beginner cards 48 comprise words to communicate skills appropriate for a student with beginner level writing skills. The instructional indicia 36 on the collection of intermediate cards 50 comprise words to communicate skills appropriate for a student with intermediate level writing skills. Finally, the instructional indicia 36 on the collection of advanced cards 52 comprise words to communicate skills appropriate for a student with advanced level writing skills.

In use, the frame 12 is laid on the support surface 24, such as a desk or table top, and the style panel 26 that is assigned to the style of writing that will be practiced is positioned on the frame 12. Additionally, the appropriate set of instruction cards 34 that pertain to the style of writing to be practiced are positioned on the frame 12. The appropriate set of instruction cards 34 are arranged on the frame 12 to follow a logical sequence of steps from beginning to end with respect to the process of writing. In this way the student has a continual visual reference as to which step of writing should be performed. Moreover, the appropriate set of instruction cards 34 are chosen from the appropriate collection of beginner cards 48, intermediate cards 50 or advanced cards 52, depending on the student′ level of writing skill. In this way students of all levels of writing skill, including special needs students, can have a visual aid to assist the student with learning the process of writing in various disciplines.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A writing instruction assembly for assisting children of various ages and skill levels to learn to write, said assembly comprising:
a frame being comprised of a magnetic material, said frame defining a writing area wherein said writing area is configured to have a piece of writing paper placed in said writing area;
a plurality of style panels, each of said style panels being comprised of a magnetic material, each of said style panels being assigned to a respective style of writing, a respective one of said style panels being magnetically attachable to said frame wherein said respective style panel is configured to identify which style of writing will be performed; and
a plurality of instruction cards, each of said instruction cards being comprised of a magnetic material, each of said instruction cards having instructional indicia being printed thereon, said indicia on said plurality of instruction cards comprising words communicating writing steps, said words on said instruction cards ranging between beginning steps of writing and ending steps of writing, said instruction cards being arranged on said frame such that said words on said instruction cards communicates a sequence of steps involved with writing wherein said instruction cards are configured to assist a student with learning the steps of writing.

2. The assembly according to claim 1, wherein:
said frame comprises a pair of first members each extending between a pair of second members, each of said first members intersecting each of said second members at a right angle such that said frame defines a rectangle, each of said first members and said second members having a first surface being exposed when said frame is positioned on a support surface; and
each of said style panels has a primary surface and a secondary surface, said primary surface of each of said style panels having indicia being printed therein, said indicia on respective ones of said style panels comprising the words “narrative writing”, “persuasive writing” and “informational writing”, said secondary surface of a respective of said style panels magnetically engaging said first surface of said frame when said respective style panel is positioned on said frame.

3. The assembly according to claim 2, wherein:
said frame comprises a pair of first members each extending between a pair of second members, each of said first members intersecting each of said second members at a right angle such that said frame defines a rectangle, said each of said first members and said second members having a first surface being exposed when said frame is positioned on a support surface; and
each of said plurality of instruction cards has a primary surface and a secondary surface, said indicia on each of said instruction cards being printed on said primary surface of said instruction cards, said secondary surface of respective ones of said instruction cards magnetically engaging said first surface of said frame when said respective instruction cards are positioned on said frame.

4. The assembly according to claim 1, wherein said plurality of instruction cards comprises a set of persuasive writing cards, a set of informational writing cards and a set of narrative writing cards, said indicia on each of said persuasive writing cards comprising words communicating steps involved with persuasive writing, said indicia on each of said informational writing cards comprising words communicating steps involved with informational writing, said indicia on each of said narrative writing cards comprising words communicating steps involved with narrative writing.

5. The assembly according to claim 4, wherein each of said set of persuasive writing cards, said set of informational writing cards and said set of narrative writing cards includes a collection of beginner cards, a collection of intermediate cards and a collection of advanced cards.

6. The assembly according to claim 5, wherein said indicia on said collection of beginner cards comprises words to communicate skills appropriate for a student with beginner level writing skills.

7. The assembly according to claim 5, wherein said indicia on said collection of intermediate cards comprises words to communicate skills appropriate for a student with intermediate level writing skills.

8. The assembly according to claim 5, wherein said indicia on said collection of advanced cards comprising words to communicate skills appropriate for a student with advanced level writing skills.

9. A writing instruction assembly for assisting children of various ages and skill levels to learn to write, said assembly comprising:
a frame being comprised of a magnetic material, said frame defining a writing area wherein said writing area is configured to have a piece of writing paper placed in said writing area, said frame comprising a pair of first members each extending between a pair of second members, each of said first members intersecting each of said second members at a right angle such that said frame defines a rectangle, each of said first members and said second members having a first surface being exposed when said frame is positioned on a support surface;
a plurality of style panels, each of said style panels being comprised of a magnetic material, each of said style panels being assigned to a respective style of writing, a respective one of said style panels being magnetically attachable to said frame wherein said respective style panel is configured to identify which style of writing will be performed, each of said style panels having a primary surface and a secondary surface, said primary surface of each of said style panels having indicia being printed therein, said indicia on respective ones of said style panels comprising the words “narrative writing”, “persuasive writing” and “informational writing”, said secondary surface of a respective of said style panels magnetically engaging said first surface of said frame when said respective style panel is positioned on said frame; and
a plurality of instruction cards, each of said instruction cards being comprised of a magnetic material, each of said instruction cards having instructional indicia being printed thereon, said indicia on said plurality of instruction cards comprising words communicating writing steps, said words on said instruction cards ranging between beginning steps of writing and ending steps of writing, said instruction cards being arranged on said frame such that said words on said instruction cards communicates a sequence of steps involved with writing wherein said instruction cards are configured to assist a student with learning the steps of writing, each of said plurality of instruction cards having a primary surface and a secondary surface, said indicia on each of said instruction cards being printed on said primary surface of said instruction cards, said secondary surface of respective ones of said instruction cards magnetically engaging said first surface of said frame when said respective instruction cards are positioned on said frame, said plurality of instruction cards comprising a set of persuasive writing cards, a set of informational writing cards and a set of narrative writing cards, said indicia on each of said persuasive writing cards comprising words communicating steps involved with persuasive writing, said indicia on each of said informational writing cards comprising words communicating steps involved with informational writing, said indicia on each of said narrative writing cards comprising words communicating steps involved with narrative writing, each of said set of persuasive writing cards, said set of informational writing cards and said set of narrative writing cards including a collection of beginner cards, a collection of intermediate cards and a collection of advanced cards, said indicia on said collection of beginner cards comprising words to communicate skills appropriate for a student with beginner level writing skills, said indicia on said collection of intermediate cards comprising words to communicate skills appropriate for a student with intermediate level writing skills, said indicia on said collection of advanced cards comprising words to communicate skills appropriate for a student with advanced level writing skills.
